(19) United States
(12) Patent Application Publication
(10) Pub. No.: US 2010/0011383 A1
(43) Pub. Date: Jan. 14, 2010

(54) Method for file handling in network switch stacking

(76) Inventor: Sahul Hameed Abdul Kader Jailani, San Jose, CA (US)

Correspondence Address: Sahul Hameed Abdul Kader Jailani, Apt 921, 4200 The Woods Drive, San Jose, CA, 95136, US

(21) Appl. No.: 12/172,226

(22) Filed: Jul. 12, 2008

(51) Int. Cl. G06F 9/54

(52) U.S. Cl. 719/330

(57) ABSTRACT

A method for handling file operations in switch stacking is described. Plurality of switches connected in switch stack is managed by master switch. When user configurations are stored in master switch also transferred to other stack members for redundancy. This invention discloses a method using a stack file module to handle the file update to remote stack members. The stack file module uses Remote Procedure Call (RPC) mechanism to access remote stack member file system. The stack file module also uses a buffering mechanism and error prediction mechanism for performance benefits. The stack file module also adjusts the size of the buffer based on the amount and frequency of data written to remote stack members.

### STATEMENT REGARDING FEDERALLY SPONSORED RESEARCH

Not Applicable

### REFERENCE TO SEQUENCE LISTING

Not Applicable

### BACKGROUND OF THE INVENTION

1. Field of Invention

This invention relates to network devices switches and routers. It is more particularly related to switch stacking where individual switching units are connected in stack for easier management.

2. Prior Art

Stackable switches are widely available in market. These switches can operate as independent switches. Also they can operate as a switch stack when these switches are connected through stack interfaces 190 as shown in Diagram FIG. 1A Stack Configuration. Switch stack provides easier management. Users can configure all switches in stack together instead of managing them individually.

In stacked switch environment one of the switches gets elected as master based on the user configured preference and or hardware parameters. All other switches in the stack act as stack members, also called slave members. If the current master switch fails, master reelection happens again and one of the stack members gets elected as new master. All the members of the stack including master carry data plane traffic. The control plane traffic is handled by only by master switch Central Processing Unit (CPU). All other stack members pass the control plane traffic to master switch for processing.

The master switch provides the management access for the whole stack. Users can use Command Line Interface (CLI) or Web Graphical User Interface (GUI) or SNMP method of management provided by master switch as shown in Diagram FIG. 1A Stack configuration. When user configurations are stored in master switch, internally these configurations are stored in all stack members also. This helps in the case of master switch failover scenarios. When current master switch fails, the newly elected master runs the stored configurations to get to ready to handle the control plane.

User configurations are categorized as different groups as system configurations, feature configurations, user management configurations, and stacking configurations.

System configuration—This group contains configurations related to system mainly Medium Access Control (MAC) address, management IP, SNMP engine identifier and etc. When user configures these parameters they are immediately stored in non-volatile flash memory 120.

Feature configuration—This group contains all switch feature configurations mainly Virtual Local Access Network (VLAN), port configurations, protocol configurations and etc. Unlike system configurations, these configurations are not stored in non-volatile flash memory 120 whenever user configures. These files are stored in flash only when user explicitly issues command to store configurations as “save configuration” or as “write configurations to flash”.

User management configurations—This group contains user account details including user names, passwords and privileges. These configurations are stored in flash immediately like system configurations.

Stacking configuration—This group contains stack member configurations mainly stack member identifiers and switch types. Stacking configurations are stored in flash immediately like system configurations.

When these configuration files are written into master switch flash 120, they also transferred to all slave stack members to store in slave switch flash memories 195. These files transfers are done using standard TFTP/FTP based file transfer modules 130 as shown in Diagram FIG. 1A Stack Configuration. Master switch initiates these file transfers to all slave units. This functionality is handled by a piece of software management module 110, as shown in Diagram FIG. 1A. Stack configuration.

This approach has the following disadvantages.

(a) The management module 110 writes into files in multiple scenarios. Different categories of configurations are written into files from different software functions. All these functions need to take care of updating slave switches by initiating file transfers. This causes repetition of file transfer initiating code in multiple functions of management module 110. Missing of this slave update in one or more functions might lead to issues in stacking functionality behavior.

(b) It becomes more difficult during software maintenance phase when new configurations are added using new functions by new engineers. These new configuration functions also need to trigger the file transfers to slaves by keeping in mind of stacking functionalities.

(c) Error conditions occurring on file transfers to slave switches also need to be handled in all the functions where these file transfers are initiated.

(d) The file transfer protocols do not support transfer of partial contents of files. The files need to be transferred fully. This becomes issue in the cases where files are big and often only a small portion is modified. For every small update, the whole file needs to be transferred to all slaves. This creates unnecessary traffic on stacking interfaces 195 connecting master and slave switches.

### SUMMARY OF THE INVENTION

This invention discloses a new software module called Stack file module which abstracts the file handling for local and remote files. This stack file module provides file handling Application Programming Interfaces (APIs) similar to standard file operations APIs provided by Operating System (OS), the API parameters are all same. The stack file module APIs takes care of writing to local master file system as well as all remote stack members file system. These APIs can be used by management module 110 software with as minimal changes as using different function names instead of standard file operation APIs. Using the stack file module APIs, management module 110 does not need to take care of writing to all remote stack members. This solves the major disadvantage of prior art solutions having spread software code on management module 110 to update remote stack members on all file handling functions. This completely relieves management module 110 with the burden of updating remote stack members. Adding new configurations are possible without any special consideration for updating remote stack members as stack file module APIs take care of it.

Also this invention proposes a buffering mechanism to get better CPU performance when frequent remote files writes are used. The stack file module writes to a local buffer and periodically flushes the local buffer contents to remote stack members.

The stack file module APIs handles the errors if any occurred while writing to remote stack members. The summary result of local file operation and all remote operations is returned to management module 110 as a single result for handling. Management module 110 does not need to differentiate the failures as local or remote as it concerned only on the overall success or failure of operation. When stack file module defers the remote file operation while buffering for better CPU performance, it predicts the possible errors that might arise when the buffer contents are flushed on next periodic cycle. This error prediction is done through tracking the available free space in remote stack member file systems. This way this invention provides superior error handling when compared to prior art methods.

This invention writes the same amount of data on remote stack member file systems as it writes on local master file system. This solves the disadvantage of transferring of full file to remote for every small change.

### BRIEF DESCRIPTION OF THE SEVERAL VIEWS OF THE DRAWING

The objects and features of the invention will be more understood with reference to the following description and the attached drawings, wherein:

FIG. 1A Stack configuration is a block diagram of modules relevant to file handling in switch stack environment.

FIG. 1B Stack configuration using stack file module is a black diagram of modules relevant to file handing in switch stack environment as disclosed in this invention.

FIG. 2A Master stack file module is a block diagram of components of stack file module designed for master switch member.

FIG. 2B Slave stack file module is a block diagram of components of stack file module designed for slave switch member.

The FIG. 3 Stack information component 240 is a flow chart of stack information component logical functionality.

The FIG. 4 File write procedure 224 is a flow chart of file write logic.

The FIG. 5 Timer expiry handler is a flow chart of periodic timer expiry handler logic.

### DETAILED DESCRIPTION OF THE INVENTION

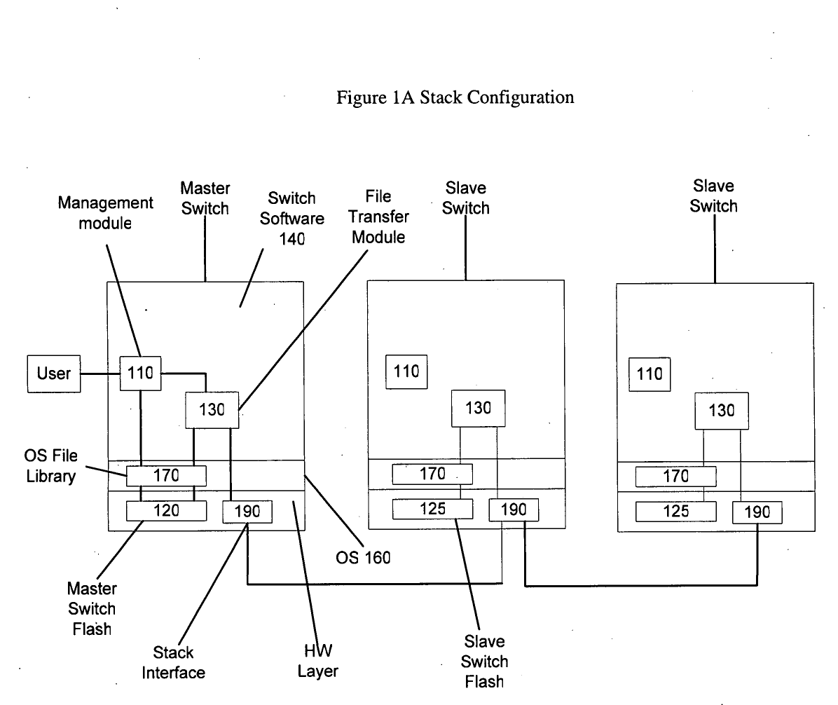

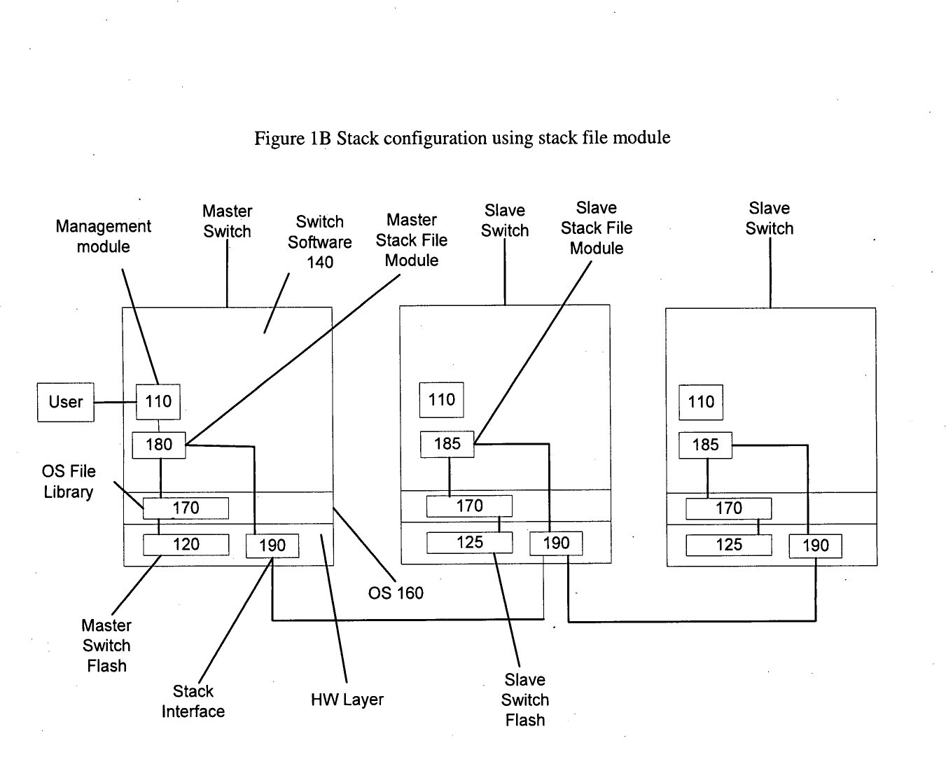

This invention discloses a new software module stack file module. It has two pieces of software modules 180 and 185 to handle the file operations as shown in drawing FIG. 1B Stack configuration using stack file module.

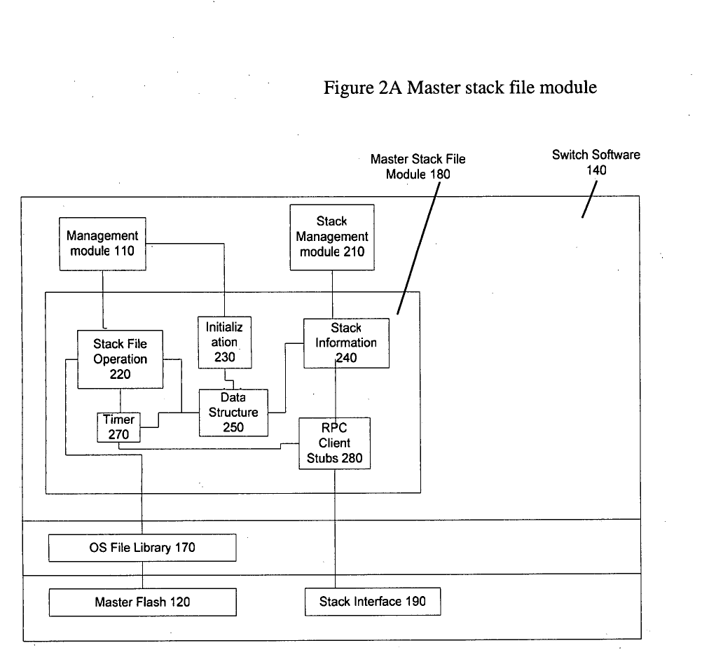

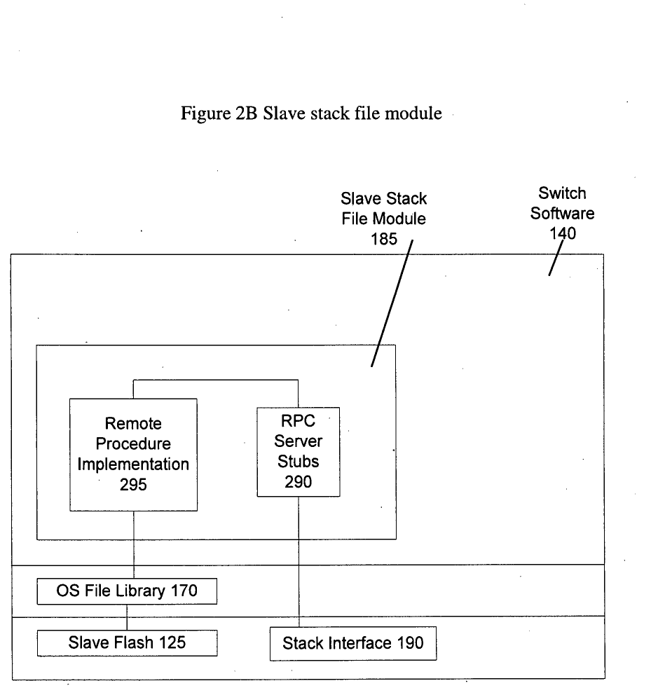

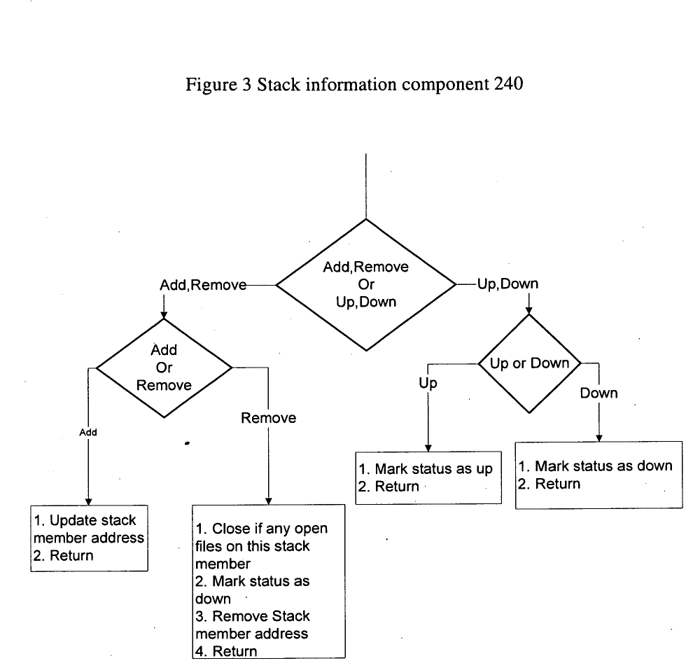

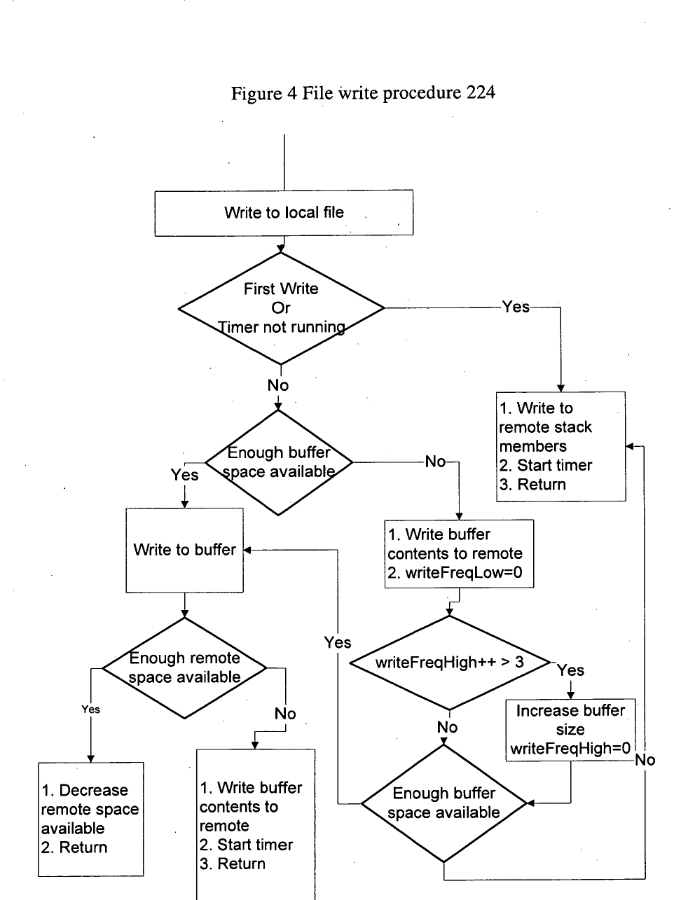

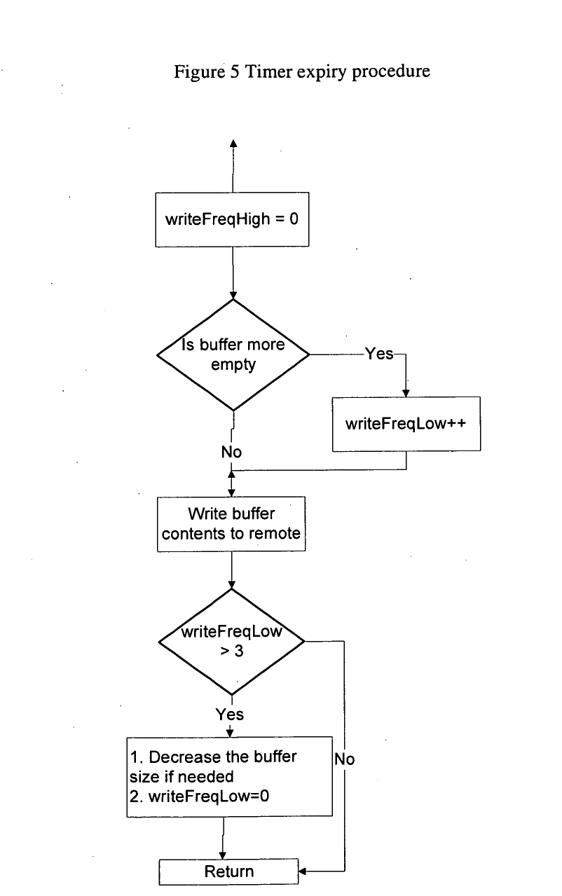

Stack file module 180 is designed for master switches; hence it is referred as master stack file module 180. The Diagram FIG. 2A. Master stack file module shows the details of master stack file module 180. The other module 185 is designed for slave members; hence it is referred as slave stack file module 185. The Diagram FIG. 2B. Slave stack file module shows the details of slave stack file module 185.

Master stack file module 180 abstracts the file operations APIs 170 provided by Operating System 160. Master stack file module 180 provides new file operation APIs for management module 110. The parameters of these APIs are same as Operating System 160 provided file operation APIs 170. Management module 110 needs to use the file handling APIs exposed by master stacking file module 180. If stacking functionality is newly added to existing management module 110, this change of using new APIs instead of standard file operation APIs 170, can be easily done through a preprocessor macro. This macro can redefine file operation APIs to new APIs exposed by master stack file module 180. Apart from this, management module 110 does not require any special handling to update slave switches.

Master stack file module 180 takes care of file operations locally to write into master switch flash 120 as well as on remote slave member flash 125. This module uses OS 160 provided standard file operation APIs 170 to manage local files in master switch. This module uses Remote Procedure Call (RPC) mechanism to manage remote file operations for slave members.

The slave stack file module 185 implements the RPC procedures used by master stack file module 180. In the context of RPC, this slave stack file module acts as server and master stack file module act as client. This slave stack file module 185 handles the remote procedure requests from master and writes to local slave switch flash 175.

The master stack file module 180 handles the remote file write innovatively. In the cases of frequent small sized file writes this module 180 buffers the file contents in a local memory buffer 260. Instead of writing every file write to remote using RPC procedure, this module 180 writes to buffer 260. When this buffer overflows, the master stack file module 180 flushes this buffer into remote switches using RPC APIs. Also this module 180 uses a timer 270 to flush the buffer contents to remote slave members using RPC procedure. This buffering mechanism helps in getting good CPU performance by reducing frequent RPC procedures.

The value of the timer 270 is chosen as long enough to save CPU cycles for good performance and short enough to avoid loss of data in case of master failures before timer expiry. The suggested value is 1 to 5 seconds and it can be tuned based on the switch software applications and operating systems.

The default size of the buffer 260 is chosen by considering the timer value 270. If the size of the buffer is small it will overflow often and initiate frequent RPC procedures. If the size of the buffer is large it increases the risk of loosing more data in case of master failures before periodic flush. The suggested default value is 1K.

If the file writes operations are large sized as closer as or larger to the size of buffer 260 and file operations are frequent than the timer value 270, it could cause overflow of buffer before timer expiry. In case of buffer overflows, the buffer contents are immediately flushed to remote and the timer is restarted. If buffer overflow happens repeatedly before timer expires, it indicates the situation of not enough buffer size. To handle this situation better, the size of the buffer is modified dynamically based on the amount of file writes. If repeatedly buffer over flow happens more than predetermined times before timer expire, the buffer size is increased. This buffer size increase can happen again when the buffer repeatedly overflows. There is a maximum buffer size limit to avoid exponential growth of buffer size because some RPC system might have data transfer size limits. When the amounts of file operations come down to the half of the increased buffer size repeatedly, the buffer size is reduced. Similar to maximum buffer size limit for increase, this decrease also will not decrease less than the default buffer size.

Master stack file module 180 also facilitates improved error handling. This module handles the error conditions originated while writing to local master flash 120 as well as the remote file write operations using RPC. If both local and remote operations are successful it returns success. If the any of these operations fails, it returns failure. This helps application software mainly management software module 110 to handle error conditions as usual as standard file operations error conditions. In this case, management software module 110 need not additionally process remote failure conditions separately.

In the cases when master stack file module 180 writes to local buffer, it innovatively predicts the failure conditions that might arise when these buffer contents are flushed later on periodic timer expiry or buffer overflow. This failure prediction is done by using the available free memory space information in remote switches. The master stack file module 180 gathers free memory space available in all remote switches when a file is opened. The least memory available is considered as important and stored in data structure 250. When master stack file module 180 writes to buffer it makes sure the free space available in remote switches by checking against information in 250. It writes to buffer only if the remote free space is well above the required space for current file write. In case of not enough remote free space, master stack file module 180 attempts the actual remote write by flushing the current buffer contents if any to confirm the non availability of remote free space. In this memory shortage alert case it gathers remote free space information again from all switches to have latest information. The remote free space is gathered using a RPC procedure as explained in later text.

The master stack file module 180 handles file read operations locally. All file read operations are done in master flash 120 file. It is not required to read the same files from remote slave members.

To provide the above functionalities the master stack file module 180 maintains required data structure 250. The data structure 250 contains information about stack members mainly the member address and status. This member status is updated by member information module 240. The data structure module 250 also contains information about every file opened mainly the file mode, local file pointer, remote file pointers, buffer size, timer status. The more details of the data structure 250 are provided in later text. This data structure module 250 is initialized by init module 230.

The member information module 240 has procedures to keep track of member additions and removals. This module 240 also keeps track of member status. This module 240 registers its procedures with appropriate switch application software stack management module 210 to get member addition, removal, status up or status down events. This information is used to attempt remote file write only for slave member switches which has status as up.

The detailed descriptions of the above discussed modules are provided below.

The master stack file module 180 consists of the following components.

Data structure component 250
Initialization component 230
Stack information component 240
RPC client stubs component 280
Stack file operations component 220

### Timer 270

### Buffer 260

Data structure component 250 has the following data elements.

Least available space—Least number among the amount of free space available in remote stack members file system
Last write status—Result of last write status as success or failure
Address and Status for every stack member

The following information is maintained for every open file.

File pointer in all members
Local file pointer
File opened mode—Read only mode or other modes
First Write Flag—Is it first write after file opened or not

### Buffer

Timer identifier
Buffer size

### Buffer Index

Write frequency high—Count to track more often file writes
Write Frequency Low—Count of track less often file writes
Timer Status as running or not running

Initialization component 230 contains just one function to initialize all member address as not available and member status as down in data structure component 250.

Stack information component 240 tracks stack members. This component should get notifications from switch application software 140 when ever user adding or removing any stack members. Also this component needs notifications when any stack member goes down or comes up. The diagram FIG. 3. Stack information component 240 shows the flow chart for this component.

RPC client stubs component 280 is generated by rpcgen utility. This rpcgen utility is freely available in internet. This utility takes remote procedure prototypes as input and generates the stubs for both server and client. This component 280 refers here the stubs generated for client. This component 280 is generated by passing the prototypes for all remotely executed file operation procedures. The following remote procedure calls are minimum required for this invention.

Get free space procedure 281
File open procedure 282
File close procedure 283
File write procedure 284

Stack file operations component 220 consists of the following procedures.

Get free space function 221
File open function 222
File close function 223
File write function 224
File read function 225

Get free space function 221 fetches the free space available in file system of all stack members. It uses RPC stub generated for Get free space procedure 281 to collect free space in stack members. It stores the minimum space reported among all stack members in data structure component 250.

File open function 222 opens the file locally using standard file open function “fopen”. It also opens the files in all stack members if the file is not opened in read only mode. If the file is opened in read only mode it can be handled with local file itself, it is not necessary to open files in remote stack members just for reading purpose. It uses RPC stub generated for file open procedure 282 to open the files in remote stack members. It adds the information about the file opened in data structure component 250. It also checks for the minimum space available in all stack members using get free space procedure 221.

File close function 223 closes the local file. If this file was not opened in read only mode, it also closes this file in all stack members using RPC stub generated for file close procedure 283. If timer is running for this file it stops the timer.

File write function 224 writes to local file. It also takes care of writing to remote stack members. It uses RPC stub generated for file write procedure 284 to write in remote stack members. Every time it writes to remote it starts the timer 270. If the next write comes before this timer expiry it writes to buffer 260 instead of writing to remote stack members immediately. If the buffer overflows, it writes to remote stack members. If the overflow conditions happened continuously predetermined times before timer expiry, it increases the buffer size not exceeding maximum buffer size limit. If the requested file write size is greater than the total buffer size, it writes to remote. The diagram FIG. 4. File write procedure 224 shows the flow chart for this function.

File read function 225 reads always from local file. It does not invoke any remote procedure calls.

Timer module 270 provides facilities to start and stop timers. File write function 224 uses this module to start and stop timers. If the timer expires it write the buffer 260 contents to remote stack members using RPC stub generated for File write procedure 284. When timer expired, the buffer is more than half empty continuously for predetermined or more times, it reduces the buffer size to default size if required. The diagram FIG. 5. Timer expiry handler shows the flow chart for this procedure.

Buffer module 260 is part of data structure module 250. It is used in File write procedure 224 and timer module 270 as described above.

The slave stack file module 185 consists of the following components.

RPC server stubs component 290
RPC procedures implementation component 295

RPC server stubs component 290 is generated by rpcgen utility along with RPC client stub component 280. It has mapping remote server stubs for every remote client stub generated in 280.

RPC procedures implementation component 295 implements the actual remote procedures for stubs generated in RPC server stubs component 290. This RPC procedures implementation component 295 supports the following procedures.

Get slave free space procedure 296—This procedure uses standard library function “statfs” to get the free space available in file system.
File open procedure 282—This procedure uses standard library function fopen to open the file.
File close procedure 283—This procedure uses standard library function fclose to close the file.
File write procedure 284—This procedure uses standard library function fwrite to write to file.

The management module 110 is available in all managed switch software already. This piece of software needs the following two changes.
A. Invoke the initialization procedure provided by initialization component 230 as part of management module initialization.
B. For files commonly available in master and slave stack members use the file operation APIs exposed by stack file operations component 220.

The stack management module 210 is part of switch application software keeps track of stack interfaces and user configuration of stack members addition and removal.

This module needs minor changes to invoke the stack information component 240 in the following conditions.
A. User adds new stack member configuration
B. User removes an existing stack member
C. Stack interface up detected for any stack member
D. Stack interface down detected for any stack member

The following other discussed modules are used as it is without any modification required for this invention. These modules are part of existing switch or router.

Standard file operation APIs 170—This includes APIs like fopen, fclose, fread, fwrite and etc.
Operating System 195—This could be any operating system used by switches.
Master flash memory 120—This could be NvRAM or EEPROM or flash based memory.
Slave flash memory 125—Similar to master flash memory 120.
Stack interface 190—This refers to physical stacking interface module like CX4 10 Gig stacking modules available in market.
Hardware layers 195—This refers the abstract hardware layer of the switch.

The above texts detailing file write handling is not limited to provide equivalent functionality for standard library function “fwrite” alone. The same logic is applied to provide equivalent functionality for other standard file write operations including fputc, fputs and fprintf. The different flavors of file read operations are handled using standard file operations to read from the local file. There is no remote procedure required to support read operations.

Also though this inventions shows master stack file module 180 and slave stack file module 185 as two different entities, in practical a software can be developed which can act as both or either one dynamically based on the role as master or slave.

As detailed on the above text this invention discloses a new improved method for handling file operations for switch stacking.

While this invention has been described with specific details and the drawings with predetermined number of stack members, it is to be understood that the invention is not limited to these specific details. To the contrary, it is intended to cover various modifications as would be apparent to those skilled in the art. Therefore, the scope of appended claims should be accorded the broadest interpretation so as to encompass all such modifications.

I claim:

1. A method of keeping all stack member files updated in stack of switches or routers comprising the steps of
(a) in a stack of switches or routers the number and status of stack members are maintained
(b) whenever a file is opened for writing locally, the same file is opened remotely on all stack members and the remotely available free space in all stack members is collected
(c) when the data is written into file for first time, the same data is written in all remotely opened files and a timer is started
(d) if further data is written into that file before the timer expired, the data is written in to a local buffer instead of writing in remotely opened files
(e) when the timer expired or the local buffer overflows, the contents of local buffer is written in to remotely opened files
(f) if any data is written into that file after the timer expired as timer is not running actively, the data is written in all remotely opened files and timer is started

2. The method of claim 1 where in using the remote stack member file system is done through using Remote Procedure Call standard method.

3. The method of claim 1 where in the writing to local buffer step comprises the following details of
(a) the least remotely available free space is checked against the amount of data to be written
(b) in the case of enough remote space available, the data is written in to local buffer
(c) in the case of not enough remote space available, the contents of local buffer if any and the currently requested data are written to remote stack members immediately. Also the remote free space available in collected from all stack members

4. The method of claim 1 where in said the buffer changes its size dynamically as per the following steps
(a) initially the size of this buffer is a predetermined default value
(b) when the buffer overflows repeatedly for a predetermined number of times before the timer expiry, the size of the buffer is increased in predetermined steps of sizes but not more than a predetermined maximum value
(c) when file writes are not often or not bigger and the buffer is used less than predetermined size, the size of the buffer is reduced in predetermined steps of sizes but not below predetermined minimum buffer size
